(19) United States
(12) Patent Application Publication
(10) Pub. No.: US 2022/0021046 A1
(43) Pub. Date: Jan. 20, 2022

(54) Housing for Rechargeable Batteries

(71) Applicant: Cadenza Innovation, Inc., Wilton, CT (US)

(72) Inventors: Jay Jie Shi, Acton, MA (US); Tord Per Jens Onnerud, Wilton, CT (US); Richard V. Chamberlain, II, Fairfax Station, VA (US)

(73) Assignee: Cadenza Innovation, Inc., Wilton, CT (US)

(21) Appl. No.: 17/264,562

(22) PCT Filed: Jul. 26, 2019
(86) PCT No.: PCT/US2019/043643

§ 371 Date: Jan. 29, 2021

Related U.S. Application Data
(60) Provisional application No. 62/711,791, filed on Jul. 30, 2018.

(51) Int. Cl. H01M 10/658; H01M 10/653; H01M 50/308; H01M 50/147; H01M 50/102

(52) U.S. Cl. CPC H01M 10/658; H01M 10/653; H01M 10/0525; H01M 50/147; H01M 50/102; H01M 50/308

(57) ABSTRACT

Lithium ion batteries are provided that include materials that provide advantageous endothermic functionalities contributing to the safety and stability of the batteries. If the temperature of the lithium ion battery rises above a predetermined level, the endothermic materials serve to provide one or more functions to prevent and/or minimize the potential for thermal runaway, e.g., thermal insulation (particularly at high temperatures); (ii) energy absorption; (iii) venting of gases produced, (iv) raising total pressure within the battery structure; (v) removal of absorbed heat from the battery system via venting of gases produced during the endothermic reaction(s) associated with the endothermic materials, and/or (vi) dilution of toxic gases (if present) and their safe expulsion from the battery system. Multi-core rechargeable electrochemical assemblies are also provided that include a plurality of jelly rolls, a negative current collector, a positive current collector, and a metal case.

### CROSS-REFERENCE TO RELATED APPLICATION

The present application claims priority benefit to a U.S. provisional application entitled “Housing for Rechargeable Batteries,” which was filed on Jul. 30, 2018 and assigned Ser. No. 62/711,791. Applicant incorporates herein by reference the content of the foregoing provisional patent application.

### FIELD OF DISCLOSURE

The present disclosure relates to lithium ion batteries and, more particularly, to multi-core lithium ion batteries having improved safety and reduced manufacturing costs.

### BACKGROUND

The demand for electro-chemical power cells, such as Lithium-ion batteries, is ever increasing due to the growth of applications such as electric vehicles and grid storage systems, as well as other multi-cell battery applications, such as electric bikes, uninterrupted power battery systems, and lead acid replacement batteries. It is a requirement for these applications that the energy and power densities are high, but just as important, if not more, are the requirements of low cost manufacturing and increased safety to enable broad commercial adoption. There is further a need to tailor the energy to power ratios of these batteries to that of the application.

For grid storage and electric vehicles, which are large format applications multiple cells connected in series and parallel arrays are required. Suppliers of cells are focused either on large cells, herein defined as more than 10 Ah (Ampere hours) for each single cell, or small cells, herein defined as less than 10 Ah. Large cells, such as prismatic or polymer cells, which contain stacked or laminated electrodes, are made by LG Chemical, AESC, ATL and other vendors. Small cells, such as 18650 or 26650 cylindrical cells, or prismatic cells such as 183765 or 103450 cells and other similar sizes, are made by Sanyo, Panasonic, EoneMoli, Boston-Power, Johnson Controls, Saft, BYD, Gold Peak, and others. These small cells often utilize a jelly roll structure of oblong or cylindrical shape. Some small cells are polymer cells with stacked electrodes, similar to large cells, but of less capacity.

Existing small and large cell batteries have some significant drawbacks. With regard to small cells, such as 18650 cells, they have the disadvantage of typically being constrained by an enclosure or a ‘can’, which causes limitations for cycle life and calendar life, due in part to mechanical stress or electrolyte starvation. As lithium ion batteries are charged, the electrodes expand. Because of the can, the jelly roll structures of the electrodes are constrained and mechanical stress occurs in the jelly roll structure, which limits its life cycle. As more and more storage capacity is desired, more active anode and cathode materials are being inserted into a can of a given volume which results in further mechanical stresses on the electrode.

Also, the ability to increase the amount of electrolyte in small cells is limited and as the lithium intercalates and de-intercalates, the electrode movement squeezes out the electrolyte from the jelly roll. This causes the electrode to become electrolyte starved, resulting in concentration gradients of lithium ions during power drain, as well as dry-out of the electrodes, causing side reactions and dry regions that block the ion path degrading battery life. To overcome these issues, especially for long life batteries, users have to compromise performance by lowering the state of charge, limiting the available capacity of the cells, or lowering the charge rate.

On the mechanical side, small cells are difficult and costly to assemble into large arrays. Complex welding patterns have to be created to minimize the potential for weld failures. Weld failures result in lowered capacity and potential heating at failed weld connections. The more cells in the array, the higher the failure risk and the lower manufacturing yields. This translates into higher product and warranty costs. There are also potential safety issues associated not only by failure issues in welds and internal shorts, but also in packaging of small cells. Proper packaging of small cells is required to avoid cascading thermal runaway as a result of a failure of one cell. Such packaging results in increased costs.

For large cells, the disadvantages are primarily around safety, low volumetric and gravimetric capacity, and costly manufacturing methods. Large cells having large area electrodes suffer from low manufacturing yields compared to smaller cells. If there is a defect on a large cell electrode, more material is wasted and overall yields are low compared to the manufacturing of a small cell. Take for instance a 50 Ah cell compared to a 5 Ah cell. A defect in the 50 Ah cell results in 10 × material loss compared to the 5 Ah cell, even if a defect for both methods of production occurs at the same rate, in term of Ah produced between faults.

A jelly roll typically has one or more pair of tabs connecting to the cathode and anode current collectors, respectively. These are in turn connected to positive and negative terminals. The tabs generally extend a certain distance out from the jelly roll, which generates some void space in a cell, reducing energy density of the battery. Furthermore, for high power applications of Li-ion batteries, such as hybrid electric vehicles (HEV), high current drain is required. In this case, one pair of tabs may not be sufficient to carry the high current loading, as it will result in excessively high temperature at the tabs, causing a safety concern. Various solutions to address these issues have been proposed in prior arts.

U.S. Pat. No. 6,605,382 discloses multiple tabs for cathode and anode. These tabs are connected to positive and negative busbars. Since tabs are generally welded on cathode and anode current collectors, multiple tabs make jelly roll fabrication, particularly the winding process, very complicated, which increases battery cost. In addition, since the areas where the tab is welded onto the current collector has no active materials coating, the multiple tab configuration reduces energy of the battery.

To solve these issues caused by multiple tabs, solutions without tabs in a Li-ion jelly roll have been proposed in the patent literature and are currently used for high power Li-ion and ultra-capacitor cells. The core part of these solutions is to make a jelly roll with non-coated, bare cathode and anode current collector areas at both ends of the jelly roll and weld transition structural components at these ends to collect current.

U.S. Pat. No. 8,568,916 discloses transitional current collector components that take the form of Al and Cu discs. These discs are connected to positive and negative terminals through metal strip leads Similar concepts have been disclosed and taught in U.S. Pat. Nos. 6,653,017, 8,233,267, US Patent Publn. No. 2010/0316897 and US Patent Publn. No. 2011/0223455. Although these disclosures may eliminate tabs from cathode and anode in a jelly roll, additional means to connect the positive and negative current collectors at the both ends of jelly roll to terminals are required, which still leaves void space in the cell, though less than in the conventional Li-ion cells having tabs. This compromises cell energy density. Furthermore, these solutions are only used in single jelly roll cells.

U.S. Pat. No. 6,605,382 discloses a positive busbar where multiple cathode tabs are connected that is directly welded onto a disc which in turn is welded to an aluminum cylinder. This eliminates the need for a can bottom, reducing cell volume and weight. But the disclosure is only used for a multiple tab system.

A number of publications have disclosed means to build a large capacity unit by connecting multiple small cells in parallel. There is a challenge for these solution to properly arrange and configure cell tabs and busbars, and they suffer from low battery energy density, low power density, high cost and low safety. In U.S. Pat. No. 8,088,509, multiple jelly rolls are positioned in individual metal shells. The tabs from jelly rolls are connected to positive and negative busbars. In U.S. Pat. No. 5,871,861, a plurality of single jelly rolls are connected in parallel. Their positive and negative tabs are connected to positive and negative busbars. In WO 2013/122448, a Li-ion cell consisting of multiple jelly roll stacks formed by stacking cathode and anode plates is disclosed. The cathode tabs and anode tabs are connected to positive and negative busbars, respectively. In the foregoing prior art disclosures, multiple jelly rolls formed by winding or electrode stacking have multiple tabs and busbars and are housed in a metal casing.

In PCT/US2013/064654, new types of multi-core Li-ion structures have been disclosed. In one of these structures, a plurality of jelly rolls are positioned in a housing with liners for individual jelly rolls. Tabs from individual jelly rolls are connected to positive and negative busbars.

Another issue for large cells is safety. The energy released in a cell going into thermal runaway is proportional to the amount of electrolyte that resides inside the cell and accessible during a thermal runaway scenario. The larger the cell, the more free space is available for the electrolyte in order to fully saturate the electrode structure. Since the amount of electrolyte per Wh for a large cell typically is greater than a small cell, the large cell battery in general is a more potent system during thermal runaway and therefore less safe. Naturally any thermal runaway will depend on the specific scenario but, in general, the more fuel (electrolyte), the more intense the fire in the case of a catastrophic event. In addition, once a large cell is in thermal runaway mode, the heat produced by the cell can induce a thermal runaway reaction in adjacent cells causing a cascading effect igniting the entire pack with massive destruction to the pack and surrounding equipment and unsafe conditions for users.

For example, various types of cells have been shown to produce temperatures in the region of 600-900° C. in thermal runaway conditions [Andrey W. Golubkov et al, Thermal-runaway experiments on consumer Li-ion batteries with metal-oxide and olivin-type cathodes RSC Adv., 2014, 4, 3633-3642]. Such high temperatures may ignite adjacent combustibles, thereby creating a fire hazard. Elevated temperature may also cause some materials to begin to decompose and generate gas. Gases generated during such events can be toxic and/or flammable, further increasing the hazards associated with uncontrolled thermal runaway events.

Lithium ion cells may use organic electrolytes that have high volatility and flammability. Such electrolytes tend to start breaking down at temperatures starting in the region 150° C. to 200° C. and, in any event, have a significant vapor pressure even before break down starts. Once breakdown commences, the gas mixtures produced (typically a mixture of CO₂, CH₄, C₂H₄, C₂H₅F and others) can ignite. The generation of such gases on breakdown of the electrolyte leads to an increase in pressure and the gases are generally vented to atmosphere; however this venting process is hazardous as the dilution of the gases with air can lead to formation of an explosive fuel-air mixture that, if ignited, can flame back into the cell in question igniting the whole arrangement.

It has been proposed to incorporate flame retardant additives into the electrolyte, or to use inherently non-flammable electrolyte, but this can compromise the efficiency of the lithium ion cell [E. Peter Roth et al., How Electrolytes Influence Battery Safety, The Electrochemical Society Interface, Summer 2012, 45-49].

It should be noted that in addition to flammable gases, breakdown may also release toxic gases.

The issue of thermal runaway becomes compounded in batteries that include a plurality of cells, since adjacent cells may absorb enough energy from the event to rise above their designed operating temperatures and so be triggered to enter into thermal runaway. This can result in a chain reaction in which storage devices enter into a cascading series of thermal runaways, as one cell ignites adjacent cells.

To prevent such cascading thermal runaway events from occurring, storage devices may be designed to keep the energy stored sufficiently low, or employ enough insulation between cells to insulate them from thermal events that may occur in an adjacent cell, or a combination thereof. The former severely limits the amount of energy that could potentially be stored in such a device. The latter limits how close cells can be placed and thereby limits the effective energy density.

There are currently a number of different methodologies employed by designers to maximize energy density while guarding against cascading thermal runaway. One method is to employ a cooling mechanism by which energy released during thermal events is actively removed from the affected area and released at another location, typically outside the storage device. This approach is considered an active protection system because its success relies on the function of another system to be effective. Such a system is not fail safe since it needs intervention by another system. Cooling systems also add weight to the total energy storage system, thereby reducing the effectiveness of the storage devices for those applications where they are being used to provide motion (e.g., electric vehicles). The space the cooling system displaces within the storage device may also reduce the potential energy density that could be achieved.

A second approach employed to prevent cascading thermal runaway is to incorporate a sufficient amount of insulation between cells or clusters of cells that the rate of thermal heat transfer during a thermal event is sufficiently low enough to allow the heat to be diffused through the entire thermal mass of the cell, typically by conduction. This approach is considered a passive method and is generally thought to be more desired from a safety vantage. In this approach, the ability of the insulating material to contain the heat, combined with the mass of insulation required dictate the upper limits of the energy density that can be achieved.

A third approach is through the use of phase change materials. These materials undergo an endothermic phase change upon reaching a certain elevated temperature. The endothermic phase change absorbs a portion of the heat being generated and thereby cools the localized region. This approach is also passive in nature and does not rely on outside mechanical systems to function. Typically, for electrical storage devices, these phase change materials rely on hydrocarbon materials, such as waxes and fatty acids for example. These systems are effective at cooling, but are themselves combustible and therefore are not beneficial in preventing thermal runaway once ignition within the storage device does occur.

A fourth method for preventing cascading thermal runaway is through the incorporation of intumescent materials. These materials expand above a specified temperature producing a char that is designed to be lightweight and provide thermal insulation when needed. These materials can be effective in providing insulating benefits, but the expansion of the material must be accounted for in the design of the storage device.

In addition, during thermal runaway of lithium ion cells, the carbonate electrolyte which also contains LiPF₆ salt, generally creates a hazardous gas mixture, not only in terms of toxicity but also flammability, as the gas includes H₂, CH₄, C₂H₆, CO, CO₂, O₂, etc. Such a mixture becomes particularly flammable when venting the cell to atmosphere. Indeed, when a critical oxygen concentration is reached in the mixture, the gas is ignited and can flame back into a cell, igniting the entire arrangement.

When comparing performance parameters of small and large cells relative to each other, it can be found that small cells in general have higher gravimetric (Wh/kg) and volumetric (Wh/L) capacity compared to large cells. It is easier to group multiples of small cells using binning techniques for capacity and impedance and thereby matching the entire distribution of a production run in a more efficient way, compared to large cells. This results in higher manufacturing yields during battery pack mass production. In addition, it is easier to arrange small cells in volumetrically efficient arrays that limit cascading runaway reactions of a battery pack, ignited by for instance an internal short in one cell (one of the most common issues in the field for safety issues). Further, there is a cost advantage of using small cells as production methods are well established at high yield by the industry and failure rates are low. Machinery is readily available and cost has been driven out of the manufacturing system.

On the other hand, the advantage of large cells is the ease of assembly for battery pack OEMs, which can experience a more robust large format structure which often has room for common electromechanical connectors that are easier to use and the apparent fewer cells that enables effective pack manufacturing without having to address the multiple issues and know-how that is required to assemble an array of small cells.

In order to take advantage of the benefits of using small cells to create batteries of a larger size and higher power/energy capability, but with better safety and lower manufacturing costs, as compared to large cells, assemblies of small cells in a multi-core (MC) cell structure have been developed.

One such MC cell structure, developed by BYD Company Ltd., uses an array of MC's integrated into one container made of metal (Aluminum, copper alloy or nickel chromium).This array is described in the following documents: EP 1952475 A0; WO2007/053990; US2009/0142658 A1; CN 1964126A. The BYD structure has only metallic material surrounding the MCs and therefore has the disadvantage during mechanical impact of having sharp objects penetrate into a core and cause a localized short. Since all the cores are in a common container (not in individual cans) where electrolyte is shared among cores, propagation of any individual failure, from manufacturing defects or external abuse, to the other cores and destruction of the MC structure is likely. Such a cell is unsafe.

Methods for preventing thermal runaway in assemblies of multiple electrochemical cells have been described in US2012/0003508 A1. In the MC structure described in this patent application, individual cells are connected in parallel or series, each cell having a jelly roll structure contained within its own can. These individual cells are then inserted into a container which is filled with rigid foam, including fire retardant additives. These safety measures are costly to produce and limit energy density, partly due to the excessive costs of the mitigating materials.

Another MC structure is described in patent applications US2010/0190081 A1 and WO2007/145441 A1, which discloses the use of two or more stacked-type secondary batteries with a plurality of cells that provide two or more voltages by a single battery. In this arrangement, single cells are connected in series within an enclosure and use of a separator. The serial elements only create a cell of higher voltage, but do not solve any safety or cost issues compared to a regularly stacked-type single voltage cell.

A phase transition material based thermal management matrix was disclosed in U.S. Pat. No. 8,273,474. In this patent, a plurality of cells are enclosed in a thermal management matrix that contains phase transition material. When the temperature reaches the phase transition temperature, some heat in the system will be absorbed due to phase transition.

Patent application US 2011/0159341 A1, disclosed a solution to include a temperature increase suppressing layer between the secondary battery and an inner surface of the molded body to suppress a temperature increase of an outer surface of the molded body. The layer contains heat absorbing agents which absorbs heat through thermal decomposition.

These MC type batteries provide certain advantages over large cell batteries; however, they still have certain shortcomings in safety and cost. In addition, from the point of increasing Li-ion battery energy density, reducing cost and improving safety, it is desirable, for lowered cost and higher performance, to (i) eliminate tabs and liners, (ii) integrate both positive current collectors and positive busbars together, (iii) integrate both negative current collectors and negative busbar together and (iv) allow a quick heat depletion at the positive current collector and busbar.

### SUMMARY

The present disclosure provides an advantageous multi-core lithium ion battery structure having reduced production costs and improved safety while maximizing energy and power densities. The advantageous systems disclosed herein have applicability in multi-core cell structures and a multi-cell battery modules. It is understood by those skilled in the art that the Li-ion structures described below can also in most cases be used for other electrochemical units using an active core, such as a jelly roll, and an electrolyte.

In an exemplary embodiment, a lithium ion battery is provided that includes an assembly of multiple cores that are connected to a positive and negative current collector, originating from its anode and cathode electrodes. The lithium ion battery includes a plurality of jelly rolls, positive and negative current collectors, and a housing. The housing may be fabricated from a material or be coated with a material that is thermally and electrically conductive. For example, aluminum, nickel, copper, and any combination thereof. In some instances, aluminum may be coated on plastics or ceramics. In other instances, nickel may be coated on metals, for example metals with a lower thermal and/or electrical conductivity (e.g., steel).

The housing may include a plurality of cavities and a plurality of lithium ion core members, disposed within a corresponding one of the plurality of cavities. Jelly roll and lithium ion core member may be used interchangeably throughout this disclosure. A lithium ion core member/jelly roll as used herein is meant the smallest, independent electrochemical energy storage unit in a battery, including a cathode, an anode, and a separator. The cavities may be distributed in accordance with a desired orientation, as discussed in more detail below. In one example, each cavity has substantially similar diameters to contain similarly-sized jelly rolls. In another example, the cavities have substantially different diameters to contain variously-sized jelly rolls. The housing may further define the exterior walls of the lithium ion battery.

In one embodiment, the jelly roll has at least one bare current collector area welded directly onto a negative or positive bus bar, which is electrically joining multiple jelly rolls. In another embodiment, at least one of the bare current collector areas of the jelly rolls is directly welded onto a surrounding case structure, without using a bus bar for that connection. In this case, the case functions as the bus bar. This can be accomplished by either welding the rolls straight to the case, i.e., a metal can, or by using a current collector, where the jelly rolls are in contact with the current collector which is in turn welded onto the can structure. The bare anode current collector is generally Cu foil and the bare cathode current collector is generally Al foil for a Li-ion battery. The metal plate, which bare electrodes are welded onto, is referred to as the negative bus bar (or NBB), and the bar cathode connected bus bar end in the jelly roll is referred to as the positive bus bar (or PBB).

In one embodiment, the housing defines a plurality of cavities for corresponding lithium ion core members. Associated with the housing are panels defining the exterior walls of the lithium ion battery. The panels may be an extension of the housing or may be attached to using conventional attachment procedures (e.g., welding, fasteners, adhesives). A cover may be in direct or indirect relation to the housing. The housing may be in electrical communication with the cover. Tabs may connect the lithium ion member cathode to the housing, specifically to the base of the corresponding cavity. The anode of the lithium ion core member may be directly or indirectly in relation to the NBB, situated on the inside of the cover. Surrounding the NBB may be a material that is not electrically conductive to insulate the cover from the NBB and the housing from the NBB, both of which are positively charged. When installed, the housing and cover may create a hermetically sealed atmosphere within the enclosure. The cover may include a positively charged terminal mounted therewith and a negative terminal may be accessible through the cover.

In another embodiment, the assembly illustrated above may further include fillers surrounding the plurality of cavities. Specifically, the plurality of cavities may be surrounded with heat absorption materials. The heat absorption materials may further provide fire retardant capabilities. The filler may be injected into the housing, in the form of a foam or liquid, or may be pellets included through the opening prior to installation of the cover.

In yet another embodiment, the housing defines a plurality of cavities for corresponding lithium ion core members. The housing includes sidewalls and a base which extends perpendicularly in relation to the sidewalls. A cover may be in direct or indirect relation to the housing. Tabs may connect the lithium ion member cathode to the housing, specifically to the base of the corresponding cavity. The anode of the lithium ion core member may be directly or indirectly in relation to the NBB. When installed, the housing and cover may create a hermetically sealed atmosphere within the enclosure. The NBB may be situated outside of the hermetically sealed enclosure and insulated from the cover/housing. The cover may include a positively charged terminal mounted therewith and the NBB may be mounted in close proximity to the cover, separated by an insulator.

In yet another embodiment, the housing defines a plurality of cavities for corresponding lithium ion core members. The housing includes sidewalls and a base, which is attached perpendicularly in relation to the sidewalls. A cover may be in direct or indirect relation to the housing. The housing may be in electrical communication with the cover. Current collectors may be situated between the cathode of the lithium ion core member and the base of each of the plurality of cavities. The anode of the lithium ion core member may be directly or indirectly in relation to the NBB, situated on the inside of the cover. Surrounding the NBB may be a material that is not electrically conductive to insulate the cover from the NBB and the housing from the NBB, both of which are positively charged. When installed, the housing and cover may create a hermetically sealed atmosphere within the enclosure. The cover may include a positively charged terminal mounted therewith and a negative terminal may be accessible through the cover.

In another embodiment, there are slit openings corresponding to the position of each individual jelly rolls of the NBB to allow an opening for electrolyte filling. This allows for some cases the electrolyte to be contained by the jelly roll itself and no additional electrolyte containing components, such as metal or plastic liners, are needed. There is further included an electrolyte contained within each of the jelly roles and the electrolyte includes at least one of a flame retardant, a gas generating agent, and a redox shuttle. Each lithium ion core member includes an anode, a cathode and separator disposed between each anode and cathode. There is further included an electrical connector within said enclosure electrically connecting the core members to an electrical terminal external to the sealed enclosure. The electrical connector includes two bus bars, the first bus bar interconnecting the anodes of the core members to a positive terminal member of the terminal external to the enclosure, and the second bus bar interconnecting the cathodes of the core members to a negative terminal member of the terminal external to the enclosure.

In another aspect of the disclosure, the core members are connected in parallel or they are connected in series. Alternatively, a first set of core members are connected in parallel and a second set of core members are connected in parallel, and the first set of core members is connected in series with the second set of core members. The enclosure includes a wall having a compressible element which, when compressed due to a force impacting the wall, creates an electrical short circuit of the lithium ion battery. The cavities in the housing and their corresponding core members are one of cylindrical, oblong, and prismatic in shape. The at least one of the cavities and its corresponding core member may have different shapes than the other cavities and their corresponding core members.

In another aspect of the disclosure, the at least one of the core members has high power characteristics and at least one of the core members has high energy characteristics. The anodes of the core members are formed of the same material and the cathodes of the core members are formed of the same material. Each separator member may include a ceramic coating and each anode and each cathode may include a ceramic coating. At least one of the core members includes one of an anode and cathode of a different thickness than the thickness of the anodes and cathodes of the other core members. At least one cathode includes at least two out of the Compound A through M group of materials. Each cathode includes a surface modifier. Each anode includes Li metal or one of carbon or graphite. Each anode includes Si. Each anode may further include lithium titanate (such as Li₂TiO₃ or Li₄Ti₅O₁₂). Each core member includes a rolled anode, cathode and separator structure or each core member includes a stacked anode, cathode and separator structure.

In another aspect of this disclosure, the core members have substantially the same electrical capacity. At least one of the core members has a different electrical capacity as compared to the other core members. At least one of the core members is optimized for power storage and at least one of the core members is optimized for energy storage. There is further included a tab for electrically connecting each anode to the first bus bar and a tab for electrically connecting each cathode to the housing, wherein each tab includes a means for interrupting the flow of electrical current through each said tab when a predetermined current has been exceeded. The first bus bar includes a fuse element, proximate each point of interconnection between the anodes to the first bus bar and the housing includes a fuse element proximate each point of interconnection between the cathodes to the housing, for interrupting the flow of electrical current through the fuse elements when a predetermined current has been exceeded. The cathode may further be connected to a bus bar, which is then connected to the housing.

In yet another aspect of the disclosure, sensing wires are electrically interconnected with the core members and configured to enable electrical monitoring and balancing of the core members. The sealed enclosure includes a fire retardant member and the fire retardant member includes a fire retardant mesh material affixed to the exterior of the enclosure.

In another aspect of the disclosure, there is an electrolyte contained within each of the cores and the electrolyte includes at least one of a flame retardant, a gas generating agent, and a redox shuttle. Each lithium ion core member includes an anode, a cathode and separator disposed between each anode and cathode. There is further included an electrical connector within the enclosure electrically connecting the core members to an electrical terminal external to the sealed enclosure. The electrical connector may include two bus bars, the first bus bar interconnecting the anodes of the core members to a positive terminal member of the terminal external to the enclosure, and the second bus bar interconnecting the cathodes of the core members to a negative terminal member of the terminal external to the enclosure. However, the second bus bar may be eliminated and the cathodes of the core members may be interconnected to the housing directly/indirectly. The core members may be connected in parallel. The core members may be connected in series. A first set of core members may be connected in parallel and a second set of core members may be connected in parallel, and the first set of core members may be connected in series with the second set of core members.

In another aspect, the lithium enclosure includes a wall having a compressible element which, when compressed due to a force impacting the wall, creates an electrical short circuit of the lithium ion battery. The cavities in the housing and their corresponding core members are one of cylindrical, oblong, and prismatic in shape. At least one of the cavities and its corresponding core member may have different shapes as compared to the other cavities and their corresponding core members. At least one of the core members may have high power characteristics and at least one of the core members may have high energy characteristics. The anodes of the core members may be formed of the same material and the cathodes of the core members may be formed of the same material. Each separator member may include a ceramic coating. Each anode and each cathode may include a ceramic coating. At least one of the core members may include one of an anode and cathode of a different thickness as compared to the thickness of the anodes and cathodes of the other core members.

In yet another aspect, at least one cathode includes at least two out of the Compound A through M group of materials. Each cathode may include a surface modifier. Each anode includes Li metal, carbon, graphite or Si. Each anode may further include lithium titanate (such as Li₂TiO₃ or Li₄Ti₅O₁₂). Each core member may include a rolled anode, cathode and separator structure. Each core member may include a stacked anode, cathode and separator structure. The core members may have substantially the same electrical capacity. At least one of the core members may have a different electrical capacity as compared to the other core members. At least one of the core members may be optimized for power storage and at least one of the core members may be optimized for energy storage.

In another aspect of the disclosure, there is further included a tab for electrically connecting each anode to the first bus bar and a tab for electrically connecting each cathode to the housing, wherein each tab includes a means/mechanism/structure for interrupting the flow of electrical current through each said tab when a predetermined current has been exceeded. The first bus bar may include a fuse element, proximate each point of interconnection between the anodes to the first bus bar and a fuse element and/or proximate each point of interconnection between the cathodes to the housing, for interrupting the flow of electrical current through the fuse elements when a predetermined current has been exceeded. There may further be included a protective sleeve surrounding each of the core members and each protective sleeve may be disposed outside of the cavity containing its corresponding core member.

In another embodiment of the disclosure, sensing wires are electrically interconnected with the core members configured to enable electrical monitoring and balancing of the core members. The sealed enclosure may include a fire retardant member and the fire retardant member may include a fire retardant mesh material affixed to the exterior of the enclosure.

In another embodiment, a lithium ion battery is described and includes a sealed enclosure and at least one lithium ion core member disposed within the sealed enclosure. The lithium ion core member include an anode and a cathode, wherein the cathode includes at least two compounds selected from the group of Compounds A through M. There may be only one lithium ion core member. The sealed enclosure may be a polymer bag or the sealed enclosure may be a metal canister. Each cathode may include at least two compounds selected from group of compounds B, C, D, E, F, G, L and M and may further include a surface modifier. Each cathode may include at least two compounds selected from group of Compounds B, D, F, G, and L. The battery may be charged to a voltage higher than 4.2V. Each anode may include one of carbon and graphite. Each anode may include Si.

In yet another embodiment, a lithium ion battery is described having a sealed enclosure and at least one lithium ion core member disposed within the sealed enclosure. The lithium ion core member includes an anode and a cathode. An electrical connector within the enclosure electrically connects the at least one core member to an electrical terminal external to the sealed enclosure; wherein the electrical connector includes a means/mechanism/structure for interrupting the flow of electrical current through the electrical connector when a predetermined current has been exceeded. The electrical connector includes two bus bars, the first bus bar interconnecting the anodes of the core members to a positive terminal member of the terminal external to the enclosure, and the second bus bar interconnecting the cathodes of the core members to a negative terminal member of the terminal external to the enclosure. The electrical connector may further include a tab for electrically connecting each anode to the first bus bar tab and/or for electrically connecting each cathode to the second bus bar, wherein each tab includes a means/mechanism/structure for interrupting the flow of electrical current through each tab when a predetermined current has been exceeded. The first bus bar may include a fuse element, proximate each point of interconnection between the anodes to the first bus bar, and the second bus bar may include a fuse element, proximate each point of interconnection between the cathodes to the second bus bar, for interrupting the flow of electrical current through the fuse elements when a predetermined current has been exceeded.

The present disclosure further provides lithium ion batteries that include, inter alia, materials that provide advantageous endothermic functionalities that contribute to the safety and/or stability of the batteries, e.g., by managing heat/temperature conditions and reducing the likelihood and/or magnitude of potential thermal runaway conditions. In exemplary implementations of the present disclosure, the endothermic materials/systems include a ceramic matrix that incorporates an inorganic gas-generating endothermic material. The disclosed endothermic materials/systems may be incorporated into the lithium battery in various ways and at various levels, as described in greater detail below.

In use, the disclosed endothermic materials/systems operate such that if the temperature rises above a predetermined level, e.g., a maximum level associated with normal operation, the endothermic materials/systems serve to provide one or more functions for the purposes of preventing and/or minimizing the potential for thermal runaway. For example, the disclosed endothermic materials/systems may advantageously provide one or more of the following functionalities: (i) thermal insulation (particularly at high temperatures); (ii) energy absorption; (iii) venting of gases produced, in whole or in part, from endothermic reaction(s) associated with the endothermic materials/systems, (iv) raising total pressure within the battery structure; (v) removal of absorbed heat from the battery system via venting of gases produced during the endothermic reaction(s) associated with the endothermic materials/systems, and/or (vi) dilution of toxic gases (if present) and their safe expulsion (in whole or in part) from the battery system. It is further noted that the vent gases associated with the endothermic reaction(s) dilute the electrolyte gases to provide an opportunity to postpone or eliminate the ignition point and/or flammability associated with the electrolyte gases.

The thermal insulating characteristics of the disclosed endothermic materials/systems are advantageous in their combination of properties at different stages of their application to lithium ion battery systems. In the as-made state, the endothermic materials/systems provide thermal insulation during small temperature rises or during the initial segments of a thermal event. At these relatively low temperatures, the insulation functionality serves to contain heat generation while allowing limited conduction to slowly diffuse the thermal energy to the whole of the thermal mass. At these low temperatures, the endothermic materials/systems materials are selected and/or designed not to undergo any endothermic gas-generating reactions. This provides a window to allow for temperature excursions without causing any permanent damage to the insulation and/or lithium ion battery as a whole. For lithium ion type storage devices, the general range associated as excursions or low-level rises are between 60° C. and 200° C. Through the selection of inorganic endothermic materials/systems that resist endothermic reaction in the noted temperature range, lithium ion batteries may be provided that initiate a second endothermic function at a desired elevated temperature. Thus, according to the present disclosure, it is generally desired that endothermic reaction(s) associated with the disclosed endothermic materials/systems are first initiated in temperature ranges of from 60° C. to significantly above 200° C. Exemplary endothermic materials/systems for use according t the present disclosure include, but are not limited to:

TABLE 1

| | | Approximate onset of |
|---|---|---|
| Mineral | Chemical Formula | Decomposition (° C.) |
| Nesquehonite | MgCO₃•3H₂O | 70-100 |
| Gypsum | CaSO₄•2H₂O | 60-130 |
| Magnesium phosphate octahydrate | Mg₃(PO₄)₂•8H₂O | 140-150 |
| Aluminium hydroxide | Al(OH)₃ | 180-200 |
| Hydromagnesite | Mg₅(CO₃)₄(OH)₂•4H₂O | 220-240 |
| Dawsonite | NaAl(OH)₂CO₃ | 240-260 |
| Magnesium hydroxide | Mg(OH)₂ | 300-320 |
| Magnesium carbonate subhydrate | MgO•CO_{2(0.95)}H₂O_{(0.3)} | 340-350 |
| Boehmite | AlO(OH) | 340-350 |
| Calcium hydroxide | Ca(OH)₂ | 430-450 |

These endothermic materials typically contain hydroxyl or hydrous components, possibly in combination with other carbonates or sulphates. Alternative materials include non-hydrous carbonates, sulphates and phosphates. A common example would be sodium bicarbonate which decomposes above 50° C. to give sodium carbonate, carbon dioxide and water. If a thermal event associated with a lithium ion battery does result in a temperature rise above the activation temperature for endothermic reaction(s) of the selected endothermic gas-generating material, then the disclosed endothermic materials/systems material will advantageously begin absorbing thermal energy and thereby provide both cooling as well as thermal insulation to the lithium ion battery system. The amount of energy absorption possible generally depends on the amount and type of endothermic gas-generating material incorporated into the formula, as well as the overall design/positioning of the endothermic materials/systems relative to the source of energy generation within the lithium ion battery. The exact amount of addition and type(s) of endothermic materials/systems for a given application are selected to work in concert with the insulating material such that the heat absorbed is sufficient to allow the insulating material to conduct the remaining entrapped heat to the whole of the thermal mass of the energy storage device/lithium ion battery. By distributing the heat to the whole thermal mass in a controlled manner, the temperature of the adjacent cells can be kept below the critical decomposition or ignition temperatures. However, if the heat flow through the insulating material is too large, i.e., energy conduction exceeds a threshold level, then adjacent cells will reach decomposition or ignition temperatures before the mass as a whole can dissipate the stored heat.

With these parameters in mind, the insulating materials associated with the present disclosure are designed and/or selected to be thermally stable against excessive shrinkage across the entire temperature range of a typical thermal event for lithium ion battery systems, which can reach temperatures in excess of 900° C. This insulation-related requirement is in contrast to many insulation materials that are based on low melting glass fibers, carbon fibers, or fillers which shrink extensively and even ignite at temperatures above 300° C. This insulation-related requirement also distinguishes the insulation functionality disclosed herein from intumescent materials, since the presently disclosed materials do not require design of device components to withstand expansion pressure. Thus, unlike other energy storage insulation systems using phase change materials, the endothermic materials/systems of the present disclosure are not organic and hence do not combust when exposed to oxygen at elevated temperatures. Moreover, the evolution of gas by the disclosed endothermic materials/systems, with its dual purpose of removing heat and diluting any toxic gases from the energy storage devices/lithium ion battery system, is particularly advantageous in controlling and/or avoiding thermal runaway conditions.

According to exemplary embodiments, the disclosed endothermic materials/systems desirably provide mechanical strength and stability to the energy storage device/lithium ion battery in which they are used. The disclosed endothermic materials/systems may have a high porosity, i.e., a porosity that allows the material to be slightly compressible. This can be of benefit during assembly because parts can be press fit together, resulting in a very tightly held package. This in turn provides vibrational and shock resistance desired for automotive, aerospace and industrial environments.

Of note, the mechanical properties of the disclosed endothermic materials/systems generally change if a thermal event occurs of sufficient magnitude that endothermic reaction(s) are initiated. For example, the evolution of gases associated with the endothermic reaction(s) may reduce the mechanical ability of the endothermic materials/systems to maintain the initial assembled pressure. However, energy storage devices/lithium ion batteries that experience thermal events of this magnitude will generally no longer be fit-for-service and, therefore, the change in mechanical properties can be accepted for most applications. According to exemplary implementations of the present disclosure, the evolution of gases associated with endothermic reaction(s) leaves behind a porous insulating matrix.

The gases produced by the disclosed endothermic gas-generating endothermic materials/systems include (but are not limited to) CO₂, H₂O and/or combinations thereof. The evolution of these gases provides for a series of subsequent and/or associated functions. First, the generation of gases between an upper normal operating temperature and a higher threshold temperature above which the energy storage device/lithium ion battery is liable to uncontrolled discharge/thermal runaway can advantageously function as a means of forcing a venting system for the energy storage device/lithium ion battery to open.

The generation of the gases may serve to partially dilute any toxic and/or corrosive vapors generated during a thermal event. Once the venting system activates, the released gases also serve to carry out heat energy as they exit out of the device through the venting system. The generation of gases by the disclosed endothermic materials/systems also helps to force any toxic gases out of the energy storage device/lithium ion battery through the venting system. In addition, by diluting any gases formed during thermal runaway, the potential for ignition of the gases is reduced.

The endothermic materials/systems may be incorporated and/or implemented as part of energy storage devices/lithium ion battery systems in various ways and at various levels. For example, the disclosed endothermic materials/systems may be incorporated through processes such as dry pressing, vacuum forming, infiltration and direct injection. Moreover, the disclosed endothermic materials/systems may be positioned in one or more locations within an energy storage device/lithium ion battery so as to provide the desired temperature/energy control functions.

Additional advantageous features, functions and implementations of the disclosed energy storage systems and methods will be apparent from the description of exemplary embodiments described below, particularly when read in conjunction with the appended figures.

### BRIEF DESCRIPTION OF THE FIGURES

The systems and methods of the present disclosure will be better understood on reading the description which follows, given solely by way of non-limiting example and made with reference to the drawings in which:

FIG. 1 is a side view of a multi-core, lithium ion battery according to the present disclosure;

FIG. 2 is a side view of a multi-core, lithium ion battery with a filler material according to the present disclosure;

FIG. 3 is a side view of a multi-core, lithium ion battery according to the present disclosure;

FIG. 4 is a side view of a multi-core, lithium ion battery according to the present disclosure; and

FIG. 5 is a top down view of a plurality of cavity configurations according to the present disclosure.

### DESCRIPTION OF EXEMPLARY EMBODIMENT(S)

Referring now to the drawings, like parts are marked throughout the specification and drawings with the same reference numerals, respectively. Drawing figures are not necessarily to scale and in certain views, parts may have been exaggerated for purposes of clarity.

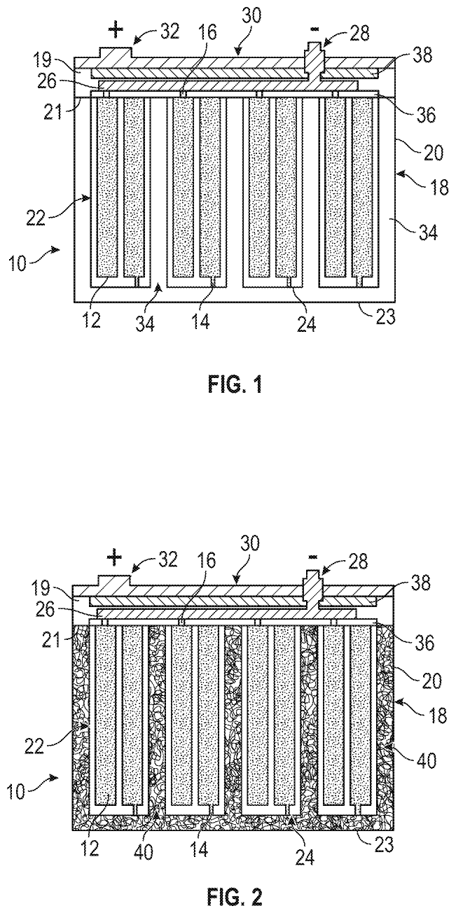

FIGS. 1 and 2 depict a multi-core (MC) enclosure 10 with housing 18 (i.e., case) and cover 30. Housing 18 includes sidewalls 20 and base 23. In some embodiments, sidewalls 20 and base 23 are fabricated together from one material (e.g., molding). In another embodiment, sidewalls 20 and base 23 are fabricated separately and are assembled together to form a sealed housing 18. In either instance, sidewalls 20 define a quadrilateral shape and further include a first edge (not visible) and a second edge (not visible) in opposition of the first edge. Base 23 is mounted in close proximity to the first edge and cover 30 is mounted in close proximity to the second edge. Base 23 and cover 30 may be in substantial alignment with one another. MC enclosure 10 is hermetically sealed. Housing 18 defines several cavities 22 that store similarly-sized lithium ion core members 12. Lithium ion core members 12 may have a jelly role core structure and a cylindrical shape. Various shape and size ion core members 12 may be used in connection with the present disclosure and certain exemplary shapes and sizes are described below. Cavities 22 are connected to sidewalls 20 and adjacent cavities 22 by ledge 21.

There is a set of electrically conductive tabs 14 connected to the cathodes of each of the core members 12 and a set of electrically conductive tabs 16 connected to the anodes of each of the core members 12. Tabs 14 are also connected to housing 18 and tabs 16 are connected to anode bus bar 26. More specifically, tabs 14 may be connected to cavity base 24, which is both electrically and physically associated with housing 18 via ledge 21. The cathode tabs 14 and the anode tabs 16 are welded to housing 18 and bus bar 26, respectively, using spot welding or laser welding techniques. Housing 18 and bus bar 26 are interconnected to negative terminal 28 and positive terminal 32, respectively, on the exterior of housing 18. In this configuration, all of the ion core members 12 are connected in parallel, but they may be connected in series or in other configurations as will be apparent to those skilled in the art.

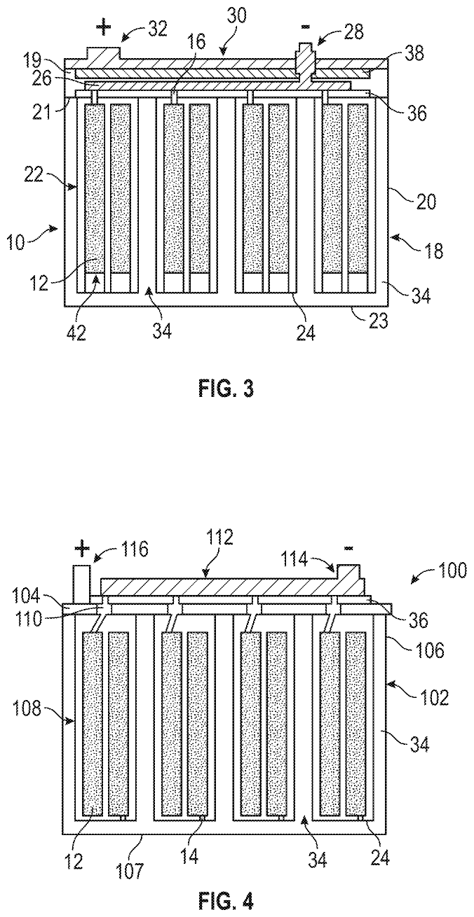

FIG. 3 depicts a MC enclosure 10 with housing 18 and cover 30, as described above. Enclosure 10 of FIG. 3 is substantially similar to enclosure 10 of FIGS. 1 and 2, except that the cathode tab has been replaced with current collector 42. Current collectors 42 are located between core member 12 and base 24 of cavity 22. Current collectors 42 may be welded to the base 24 of cavity 22. Similar to FIGS. 1 and 2, cathode is in electrical communication with housing 18.

Housing 18 and cover 30 define/interface with shared atmosphere region 19. Shared atmosphere region 19 occupies a portion of housing 18, defined by the space above lithium ion core members 12 and below cover 30. In one embodiment, shared atmosphere region 19 may be approximately defined by the volume between cover 30 and ledge 21. Bus bar 26 may be situated within shared atmosphere region 19, insulated by insulation 36, between bus bar 26 and core members 12, and insulation 38, between bus bar 26 and cover 30.

In another exemplary embodiment, FIG. 4 depicts a multi-core (MC) enclosure 100 with housing 102 (i.e., case) and cover 104. Housing 102 includes sidewalls 106 and base 107. In some embodiments, sidewalls 106 and base 107 are fabricated together from one material (e.g., molding). In another embodiment, sidewalls 106 and base 107 are fabricated separately and are assembled together to form a sealed housing 102. In either instance, sidewalls 106 define a quadrilateral shape and further include a first edge (not visible) and a second edge (not visible) in opposition of the first edge. Base 107 is mounted in close proximity to the first edge and cover 104 is mounted in close proximity to the second edge. MC enclosure 100 is hermetically sealed. Housing 102 includes several cavities 108 that store similarly-sized lithium ion core members 12. Lithium ion core members 12 may have a jelly role core structure and a cylindrical shape. Various shape and size ion core members 12 may be used in connection with the present disclosure and certain exemplary shapes and sizes are described below. Cavities 108 are connected to sidewalls 106 and adjacent cavities 108 by cover 104.

There is a set of electrically conductive tabs 14 connected to the cathodes of each of the core members 12 and a set of electrically conductive tabs 110 connected to the anodes of each of the core members 12. Tabs 14 are also connected to housing 102 and tabs 110 are connected to anode bus bar 112. More specifically, tabs 14 may be connected to cavity base 24, which is both electrically and physically associated with housing 102. The cathode tabs 14 and the anode tabs 110 are welded to housing 102 and bus bar 112, respectively, using spot welding or laser welding techniques. Housing 102 and bus bar 112 are interconnected to negative terminal 114 and positive terminal 116, respectively, on the exterior of housing 102. Unlike previous embodiments, where anode bus bar 112 was integrated within a shared atmosphere of an enclosure, this embodiment focuses on encapsulating core members 12 within individual cavities 108, having individual atmospheres. In this configuration, all of the ion core members 12 are connected in parallel, but they may be connected in series or in other configurations as will be apparent to those skilled in the art.

In one embodiment, cavities 22, 108 may be fabricated with housing 18, 102 to form a unitary case. In one instance, housing 18, 102 and cavities 22, 108 may be molded together. In another instance, housing 18, 102 and cavities 22, 108 may be 3D printed, which offers vast stylistic and functional opportunities. In another embodiment, cavities 22, 108 and housing 18, 102 are at least two distinct components that are mounted directly/indirectly with one another to create a integrated case. For instance, cavities 22, 108 may be attached in close proximity to sidewalls 20, 106 by welding or fasteners. Regardless of attachment, cavities 22, 108 and enclosure 10, 100 must remain in electrical communication.

In either instance, cavities 22, 108 are constructed so that ion core members 12 may be housed with adequate separation, so that limited expansion can take place during charge and discharge reactions thereby preventing mechanical interaction of individual ion core members 12. Furthermore, cylindrical cavities 22, 108 may have openings with a diameter that is slightly larger than those of lithium ion core members 12. Housing 18, 102 and cover 30, 104 may be fabricated from a thermally and electrically conductive material. Such as, aluminum coated plastics, aluminum coated ceramics, nickel coated steel, among others.

In another example, at least a portion of housing 18, 102 and/or cover 30, 104 may be fabricated from a thermally insulating mineral material (e.g., AFB® material, Cavityrock® material, ComfortBatt® material, and Fabrock® material (Rockwool Group, Hedehusene, Denmark); Promafour® material, Microtherm® material (Promat Inc., Tisselt, Belgium); and/or calcium-magnesium-silicate wool products from Morgan Thermal Ceramics (Birkenhead, United Kingdom). The thermally insulating mineral material may be used as a composite and include fiber and/or powder matrices. The mineral matrix material may be selected from a group including alkaline earth silicate wool, basalt fiber, asbestos, volcanic glass fiber, fiberglass, cellular glass, and any combination thereof. The mineral material may include binding materials, although it is not required. The disclosed building material may be a polymeric material and may be selected from a group including nylon, polyvinyl chloride (“PVC”), polyvinyl alcohol (“PVA”), acrylic polymers, and any combination thereof. The mineral material may further include flame retardant additives, although it is not required, an example of such includes Alumina trihydrate (“ATH”). The mineral material may be produced in a variety of mediums, such as rolls, sheets, and boards and may be rigid or flexible. For example, the material may be a pressed and compact block/board or may be a plurality of interwoven fibers that are spongey and compressible. Mineral material may also be at least partially associated with the inner wall of housing 18, 102 and/or cover 30, 104, so as to provide an insulator internal of housing 18, 102 and/or cover 30, 104.

In some enclosure embodiments, see FIGS. 1-3, openings are exposed to shared atmosphere region 19 within enclosure 10. Without having individual smaller enclosures (such as a can or polymer bag that hermetically provides a seal between the active core members), the anodes/cathodes of the core members are also directly exposed to the shared environment region 19. Not only does the elimination of the canned core members reduce manufacturing costs, it may also increase safety. In the event of a failure of a core member and a resulting fire, the gasses expelled are able to occupy the shared environment region 19, which provides significantly more volume than would be available in a typical individually ‘canned’ core member. With the canned core member pressure build up, an explosion is more likely than with the present invention, which provides a greater volume for the gases to occupy and therefore reduced pressure build up. In addition, a can typically ruptures at much higher pressures than the structure of the invention, resulting in a milder failure mode with the present invention.

In enclosures with or without a shared atmosphere, pressure disconnect devices (PDDs) and/or vents, designed to respond to a pressure build up at a predetermined pressure threshold, may be utilized. Specifically for enclosures without a shared atmosphere, vents may be associated with each cavity. See publication WO 2017/106349, which is hereby incorporated by reference. As an alternative or in addition to the above PDDs/vents, sidewalls 20, 106 may include holes to allow gases generated by heat absorption materials (from filler 40 or support structure, discussed below) to vent out. Such gases may be generated by endothermic decomposition of aluminum trihydrate (ATH) and sodium bicarbonate, among others.

In an exemplary embodiment, housing 18, 102 includes base 23, 107 and a plurality of sidewalls 20, 106 that define one or more hollow spaces 34. One or more hollow spaces 34 may partially or fully surround cavity 22, 108. Housing 18, 102 may be hollow such that there are one or more hollow spaces (i.e., void(s)) between sidewall 20, 106 and cavity 22, 108, between each adjacent cavity 22, 108, and/or between cavity 22, 108 and base 23, 107. The disclosed hollow space(s) (i.e., void(s)) 34 eliminate and/or minimize the need for a rigid support member and provide flexibility, if desired, to partially or fully fill void 34 with a filler. Filler 40 may provide enhanced performance characteristics to protect core members 12, discussed in more detail below. Any of the above embodiments may include filler 40. Hollow housing 18, 102 may be fabricated from a molding process, extruding process, machining process, drawing process, and a combination thereof. Housing 18, 102 may be fabricated with a conductive material or may be coated with a conductive material if the fabricating material is not sufficiently conductive.

In one embodiment, filler 40 may be introduced into enclosure 10, 100 through an injection process. Specifically, filler 40 may be introduced into one or more hollow spaces (i.e., void(s)) 34 after assembly of housing 18, 102 and cover 30, 104. In such instance, introduction of filler 40 may occur through an interface feature within housing 18, 102 and/or cover 30, 104. Such interface feature may include a one-way port that allows filler 40 to flow into enclosure 10, 100, but limits (or reduces) filler 40 escapement.

In another embodiment, filler 40 may be introduced into enclosure 10, 100 prior to assembly. Specifically, void 34 of housing 18, 102 may be filled prior to installation of cover 30, 104. In such instance, filler 40 may be allowed to set, if necessary, prior to installation of cover 30, 104 or may set a period of time after installation of cover 30, 104. Housing 18, 102 may further be assembled as a clamshell design. Filler 40 may be added to either side of the clamshell and allowed to cure prior to assembly. Alternatively, clamshell halves may be assembled prior to curing. In another example, as described above, filler may be introduced through an injection process after installation of the clamshell.

Filler 40 may include one or more constituents that exhibit endothermic properties. Filler 40 may be optimized to transfer heat rapidly throughout the housing and distribute it evenly throughout the battery or limit heat exposure between cores, should one core experience thermal runaway during abuse. Specifically, it is desired that the thermal conductivity be tailored to the application by means of dispersing heat during charge and discharge of the battery, creating a uniform temperature distribution, and by means of diverging heat during a catastrophic failure, such as an internal short causing thermal runaway of one core member. Proper heat dispersing properties would limit the chance of cascading runaway between cores. Besides greater safety, this will increase battery life by limiting maximum operating temperatures and enable the battery to have no, or passive, thermal management. Most importantly, the thermal characteristics of filler 40 help to prevent failure propagation from a failed core member to other core members due to the optimized heat transfer properties of the material and the ability to disrupt flame propagation. Since the material is also absorptive, it can absorb leaking electrolyte into the material which can help reduce the severity of a catastrophic failure. Heat absorbent material 40 may further include fire retardant characteristics.

In another example, filler 40 may include energy absorbing characteristics in the event of an impact to the enclosure. Energy absorbers are a class of materials that generally absorb kinetic mechanical energy by compressing or deflecting at a relatively constant stress over an extended distance, and not rebounding. Springs perform a somewhat similar function, but they rebound, hence they are energy storage devices, not energy absorbers. Examples of energy absorbers are irregularly or regularly shaped media, which can be hollow or dense. Examples of hollow media are metal, ceramic or plastic spheres, which can be made compressible at various pressure forces and with the purpose of functioning as an energy absorber for crash protection. Specific examples are aluminum hollow spheres, ceramic grinding media of alumina or zirconia, and polymer hollow spheres. Examples of kinetic energy absorbing materials are foams, such as aluminum foam, plastic foams, porous ceramic structures, honeycomb structures, or other open structures, fiber filled resins, and phenolic materials. An example of fiber fillers for plastic and resin materials could be glass fiber or carbon fibers. Examples of aluminum containing energy absorbers are aluminum foam, having open or closed pores, aluminum honeycomb structures, and engineered material such as the Altucore™ and CrashLite™ materials. As the support member collapses during impact, crash or other mechanical abuse, it is important that the cores, as much as possible, are protected from penetration as to avoid internal mechanically induced shorts. This creates a safer structure.

Void 34 may also be filled with shock absorbing materials, such as foam or other structure that allows less impact to the core members, thereby further reducing the risk of internal shorts. This ruggedization can also provide means of shifting the self-vibration frequency of the internal content to the enclosure, providing increased tolerance to shock and vibration and mechanical life. Filler material 40 should preferably contain fire retardant materials that would allow extinguishing of any fire that could arise during thermal runaway of the cell or melt during the same thermal runaway, thereby taking up excess heat and limit the heating of a cell. This provides for increased safety in the case of catastrophic event. Examples of fire retardants can be found in the open engineering literature and handbooks, such as Polyurethanes Handbook published by Hanser Gardner Publications or as described in U.S. Pat. No. 5,198,473. Besides polyurethane foam also epoxy foams or glass fiber wool and similar non-chemically or electrochemically active materials, may be used as filler materials in empty spaces inside the enclosure. In particular, hollow or dense spheres or irregularly shaped particulates made of plastic, metal or ceramic can be used as low cost fillers. In the case of hollow spheres, these would provide additional means for energy absorption during a crash scenario of the multi core cell. In a special case, the support member is aluminum foam. In another special case, the support member is dense aluminum foam between 10-25% of aluminum density. In yet another special case, the pores in the aluminum foam has an average diameter that is less than 1 mm. In further exemplary implementations, endothermic materials/systems, as described in greater detail below, may be advantageously incorporated into or otherwise associated with the empty spaces inside the enclosure.

In another embodiment, filler 40 may include a thermally insulating mineral material. The thermally insulating mineral material may be used as a composite and include fiber and/or powder matrices. The mineral matrix material may be selected from a group including alkaline earth silicate wool, basalt fiber, asbestos, volcanic glass fiber, fiberglass, cellular glass, and any combination thereof. The mineral material may include binding materials, although it is not required. The disclosed building material may be a polymeric material and may be selected from a group including nylon, PVC, PVA, acrylic polymers, and any combination thereof. The mineral material may further include flame retardant additives, although it is not required, an example of such includes ATH. The mineral material may be produced in a variety of mediums, such as rolls, sheets, and boards and may be rigid or flexible. For example, the material may be a pressed and compact block/board or may be a plurality of interwoven fibers that are spongey and compressible. Mineral material may also be at least partially associated with the inner wall of housing 18, 102 and/or cover 30, 104, so as to provide an insulator internal of housing 18, 102 and/or cover 30, 104. Mineral material may be situated at least partially around cavities 22, 108 within void 34. Depending on the medium, mineral material may be cut to the dimensions of void 34 or may be densely or loosely packed around cavities 22, 108. As discussed above, filler 40 may be introduced prior to assembly or post assembly, depending on the medium and introduction method.

Housing 18, 102 with filler 40 increase the overall safety of the MC battery by a) allowing the distribution of the ion core members 12 to optimize the battery for both safety and high energy density, b) arresting rapid thermal propagation ion core members 12, while simultaneously allowing cooling, c) providing a protective crash and impact absorbing structure for ion core members 12 and the reactive chemicals, and d) use of a widely recognized fire proof material through flame arrest. It is noted that any combination of the above fillers 40, at any percentage, may be added within void 34. For example, a combination of heat absorbing and energy absorbing fillers may be utilized.

In some instances, a thin cavity liner (not shown) may be placed within each cavity 22, 108, e.g., when housing 18 is fabricated from a material that is electrically conductive. Specifically, the cavity liner (not shown) is positioned between housing 18, 102 and lithium ion core members 12. The liner is preferably made out of polypropylene, polyethylene, or any other plastic that is chemically inert to electrolyte. The liner may also be made of a ceramic or metal material, although these are at higher cost and non-preferred. However, in the case where the housing 18, 102 is electrically conductive, the liner must be electrically insulating so as to electrically isolate the core members 12 from the housing 18, 102. The cavity liners are important for multiple reasons. First, they are moisture and electrolyte impermeable. Secondly, they may contain flame retarding agents, which can quench a fire and thirdly, they allow a readily sealable plastic material to contain the electrolyte within a hermetic seal.

During manufacturing, cavities 22, 108 can be simultaneously filled with electrolyte and then simultaneously formed and graded for capacity during the continued manufacturing process. The forming process consist of charging the cell to a constant voltage, typically 4.2V and then letting the cell rest at this potential for 12-48 hours. The capacity grading takes place during a charge/discharge process, where the cell is fully discharged to a lower voltage, such as 2.5V, then charged to highest voltage, typically in a range of 4.2-4.5V, and subsequently discharged again, upon which the capacity is recorded. Multiple charge/discharge cycles may be needed to obtain an accurate capacity grading, due to inefficiencies in the charge/discharge process.

The cavity liner enables a precise and consistent amount of electrolyte to be introduced to each core member, due to its snug fit with the core. One way to accomplish the filling is with through holes in enclosure 10, 100 (housing and/or cover) which can then be filled and sealed after the electrolyte has been introduced to the cavities and processed. A jelly roll type core member having about 3 Ah capacity will need about 4-8 g of electrolyte, depending on density and surrounding porous material. Electrolyte filling is done so that entire jelly roll is equally wetted throughout the roll with no dry areas allowed. It is preferred that each core member has the equivalent amount of electrolyte from core to core, with a variation within 0.5 g, and even more preferred within 0.1 g and yet even more preferred within 0.05 g. The variation adjusts with the total amount electrolyte and is typically less than 5% or even more preferred <1% of the total amount of electrolyte per core. Placing the assembly in a vacuum helps with this filling process and is crucial for full and equal wetting of the electrodes.

In another example, similarly beneficial as the cavity liner described above, the interior of cavity 22, 108 may be plated to isolate core members 12 from housing 18, 102. Plating may be used to insulate an electrically conductive housing 18, 102 from core members 12. Cavity 22, 108 may be plated using one of the industry known techniques. Specific plating materials may include nickel plating, zinc-nickel plating. Plating of cavities is important for multiple reasons. First, it provides a moisture and electrolyte impermeable barrier. Secondly, it may contain a fire to a given cavity and thirdly, it allows containment of the electrolyte within a hermetic seal. Depending on the plating material, plating may further draw heat away from core members 12 and into the void area surrounding the cavities to assist with heat removal and reduce the likelihood of thermal runaway. The void area, as discussed above, may partially or fully include filler materials (e.g., liquids, foams, solids, partial solids) with heat absorbing capabilities, energy absorbing capabilities, and/or shock absorbing capabilities.

Alternatively, enclosure may include a combination of the above-mentioned heat absorbing methods. For example, cavities may be included within a support member. However, in contrast to the above support member, the present support member is not sized to the housing space, but rather is smaller to allow for addition of one or more of the filler materials from above. In yet another embodiment, support member may fit within the entire housing, but support member is hollow such that the support member captures the core members in a cavity, but the support member does not include any performance characteristics. Alternatively, filler is added to the support member to enhance its performance characteristics, as described above. The above alternatives are acceptable for each of the above described figures.

In another exemplary embodiment, a MC enclosure is hermetically sealed. A support structure, which can be a part of the enclosure or a separate component, is constructed so that ion core members may be housed with adequate separation, so that limited expansion can take place during charge and discharge reactions thereby preventing mechanical interaction of the individual ion core members. The enclosure may be fabricated from plastic, ceramic, or metal materials. If a metal is used, exposed steel is not preferred, and any steel container would need to be coated with an inert metal such as nickel. Preferred metals are Aluminum, Nickel or other inert metal to the chemicals used. Many types of plastic and ceramic as long as they are inert to the chemical and electrochemical environment. Examples of plastics and ceramics are polypropylene, polyethylene, alumina, zirconia. Enclosure can include a fire retardant mesh affixed to the exterior of the enclosure for the purpose of preventing fire from reaching the interior of the enclosure.

Within enclosure, in lithium ion core region, is an electrically insulated support member which can be made of ceramic, plastic, such as polypropylene, polyethylene, or other materials, such as aluminum foam. Support member may be sufficiently deformable/compressible so as to protect the core members from damage if/when an impact occurs. Energy absorbing details discussed above further apply to this embodiment. In addition it is desired that the thermal conductivity be tailored to the application by means of dispersing heat during charge and discharge of the battery, creating a uniform temperature distribution, and by means of diverging heat during a catastrophic failure, such as an internal short causing thermal runaway of one core member. Proper heat dispersing properties would limit the chance of cascading runaway between cores. The support member can also be absorptive to electrolyte, which could be constrained in the support member, should it be expelled during abuse of the core member.

Cylindrical cavities are formed in support member for receiving the lithium ion core members, one core per cavity. In this configuration, the cylindrical cavities have openings with a diameter that is slightly larger than those of the lithium ion core members. Openings face and are exposed to shared atmosphere region within enclosure. Without having individual smaller enclosures (such as a can or polymer bag that hermetically provides a seal between the active core members), the anodes/cathodes of the core members are also directly exposed to the shared environment region. Not only does the elimination of the canned core members reduce manufacturing costs, it also increases safety. In the event of a failure of a core member and a resulting fire, the gasses expelled are able to occupy the shared environment region, which provides significantly more volume than would be available in a typical individually ‘canned’ core member. With the canned core member pressure build up, an explosion is more likely than with the present invention, which provides a greater volume for the gases to occupy and therefore reduced pressure build up. In addition, a can typically ruptures at much higher pressures than the structure of the invention, resulting in a milder failure mode with the present invention.

Cavities may be plated with a material to provide enhanced performance characteristics to encapsulate core members. Particularly, plating the internal area of a cavity, which is positioned between support member and lithium ion core members. Specific plating materials may include nickel plating, zinc-nickel plating. Plating may be used to insulate an electrically conductive housing from core members. Cavity may be plated using one of the known techniques. Plating of cavities are important for multiple reasons. First, it provides a moisture and electrolyte impermeable barrier. Secondly, it may contain a fire to the compromised cavity, and thirdly, it allows containment of the electrolyte within a hermetic seal. Depending on the plating material, plating may further draw heat away from core members 12 towards the support member, which has heat absorbing capabilities.

During manufacturing, cavities 22 can be simultaneously filled with electrolyte and then simultaneously formed and graded for capacity during the continued manufacturing process. The forming process consist of charging the cell to a constant voltage, typically 4.2V and then letting the cell rest at this potential for 12-48 hours. The capacity grading takes place during a charge/discharge process, where the cell is fully discharged to a lower voltage, such as 2.5V, then charged to highest voltage, typically in a range of 4.2-4.5V, and subsequently discharged again, upon which the capacity is recorded. Multiple charge/discharge cycles may be needed to obtain an accurate capacity grading, due to inefficiencies in the charge/discharge process.

Cavity plating enables a precise and consistent amount of electrolyte to be introduced to each core member, due to its close proximity with the core. One way to accomplish the filling is with through holes in enclosure which can then be filled and sealed after the electrolyte has been introduced to the cavities and processed. A jelly roll type core member having about 3 Ah capacity will need about 4-8 g of electrolyte, depending on density and surrounding porous material. Electrolyte filling is done so that entire jelly roll is equally wetted throughout the roll with no dry areas allowed. It is preferred that each core member has the equivalent amount of electrolyte from core to core, with a variation within 0.5 g, and even more preferred within 0.1 g and yet even more preferred within 0.05 g. The variation adjusts with the total amount electrolyte and is typically less than 5% or even more preferred <1% of the total amount of electrolyte per core. Placing the assembly in a vacuum helps with this filling process and is crucial for full and equal wetting of the electrodes.

The size, spacing, shape and number of cavities in a housing can be adjusted and optimized to achieve the desired operating characteristics for the battery while still achieving the safety features described above, such as mitigating failure propagation between/among core members. Such optimization may be utilized for housings with integrated cavities and/or for housings with supplementary support members.

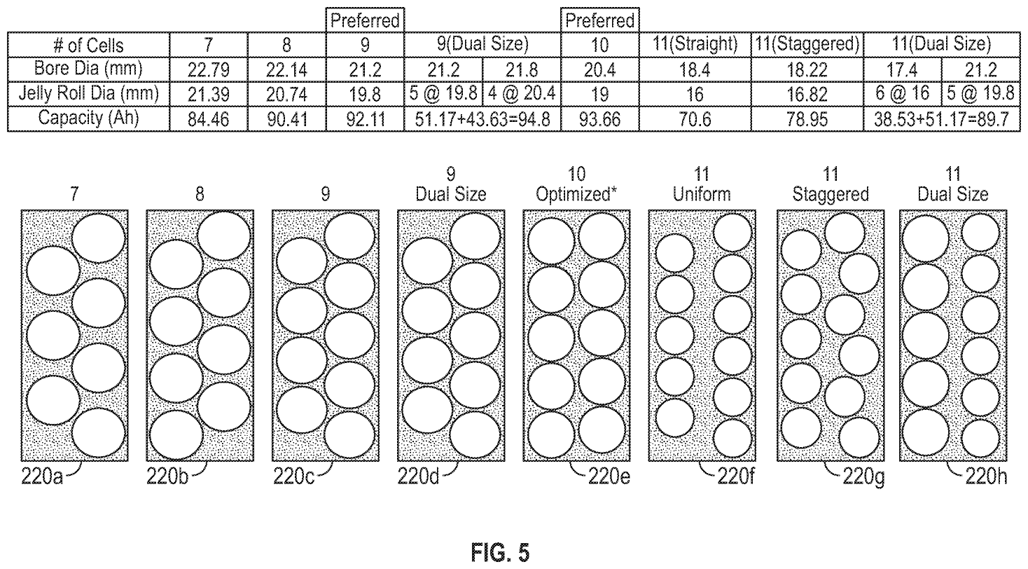

As shown in FIG. 5, cavity layouts 220a-h may have different numbers of cavities, preferably ranging from 7 to 11, and different configurations, including different size cavities as in the case of cavity layout 220d and 220h. The number of cavities is always more than 2 and is not particularly limited on the upper end, other than by geometry of the housing/support member and jelly roll size. A practical number of cavities are typically between 2 and 30. The cavities can be uniformly distributed, as in cavity layout 220f, or they can be staggered, as in the case of cavity layout 220g. Also shown in FIG. 5 are the cavity diameters and diameter of the core member that can be inserted into the cavities for each of the cavity layouts 220a-h depicted. In addition, the capacity in Ampere hours (Ah) for each configuration is shown.

In some embodiments, enclosure may consist of a plastic lid and a housing that are hermetically sealed through ultrasonic welding. At the end of enclosure opposite the side of lid is a feed through sensing contact. Extending from lid are negative battery terminal connector and positive battery terminal connector. It can be understood that various arrangements as to the position of the connectors sensing contact can be achieved by those skilled in the art and also that different serial or parallel arrangement cells can be used for the purpose of the invention.

In the case of a metal lid it is closed with welding methods, such as laser welding, and in the case of plastics, adhesives (glues) can be used, or thermal or ultrasonic weld methods can be used, or any combination thereof. This provides for a properly sealed MC battery. Jelly rolls are connected in parallel, series, or both inside the enclosure.

All feedthroughs, sensing, power, pressure, etc., needs to be hermetically sealed. The hermetical seals should withstand internal pressure of in excess or equal to about 1 atm and also vacuum, preferably more than 1.2 atm. A vent can also be housed on the container, set at a lower internal pressure than the seal allows.

Another way of providing balancing and sensing ability is to have individual connectors that provide an external lead from each of the positive and negative terminals of individual core members allowing connectors external to the container to connect with each of the individual core members. The balancing circuit detects imbalance in voltage or state-of-charge of the serial cells and would provide means of passive of active balancing known to those skilled in the art. The connecting leads are separate from the terminals providing means of leading current from the cells for the purpose of providing power from the battery and typically only used when cells are connected in series within one container. The sensing leads can optionally be fused outside the container, for avoidance of running power currents through the individual jelly rolls through the sensing circuit.

The individual core members may be connected by means of an internal bus bars, as described above. Sometimes the bus bar common connector can be a wire or plastic coated wire. It can also be a solid metal, such as copper, aluminum or nickel (e.g., current collector). The bus bar connects multiple core members in series or parallel and has the capability of transferring currents in the multi-core member structure to a connector, allowing an external connection to the multi-core array. In the case of an external bus bar, an individual feed from each jelly roll through connectors within the enclosure, are needed.

Whether internal or external bus bars are used, they can be constructed to provide a fuse between the core members. This can be accomplished in a variety of ways, including creating areas where the cross section of the bus bar is limited to only carry a certain electrical current or by limiting the tab size, which connects the core member to the bus bar. The bus bar or tabs can be constructed in one stamped out piece, or other metal forming technique, or by using a second part that connects the divisions of the bus bars with a fuse arrangement. For instance, if two rectangular cross section areas of copper bus bars are used, where anode and cathode tabs of 10 core members are connected to each of by the bus bar, each bus bar having a cross sectional surface area of 10 mm², at least one area on the bus bar can be fabricated to have a reduced surface area compared to the rest of the bus bar. This provides a position where fusing occurs and current carrying capability is limited. This fuse area can be at one or more points of the bus bar, preferably between each core member, but most effective in the case of many cells at the mid-point. If an external short were to occur, this fuse would limit the heating of the core members and potentially avoid thermal runaway. Also in the case of internal shorts in a core member, either due to manufacturing defects or due to external penetration during an abuse event, such as a nail, that penetrates into the core members causing an internal short to the cell, this fuse arrangement can limit the amount of current that is transferred to the internal short by shutting of the malfunctioning core to the other parallel cores.

For the case when the MC battery has only core members arranged in parallel, the core members may contain one or more core members that are optimized for power and one or more core members that are optimized for energy. In another special case, the MC battery may have some core members with anode or cathode using certain materials and other core members utilizing anodes and cathodes using different materials. In yet another special case, the anode or cathode, may have different thickness electrodes. Any combination of having varying electrode thickness, cathode or anode active material, or electrode formulation may be combined in a parallel string, with the objective of tailoring the energy to power ratio of the battery. Some core members may be configured to withstand rapid power pulses, while other core members may be optimized for high energy storage thus providing a battery that can handle high power pulses, while having high energy content. It is important however that the core members have chemistry that is matched electrochemically, so as to provide chemical stability in the voltage window for the chemistry chosen.

For instance, a LiCoO₂ cathode can be matched with a LiNi_{0.8}Co_{o.15}Al_{0.05}O₂ cathode, as long as an upper potential of 4.2V is used and a lower potential of about 2V to 2.5V, however, as potential goes above 4.2V, to for instance 4.3V, for instance a magnesium doped LiCoO₂ material should not be matched with an NCA material, as the NCA material degrades at the higher voltages. However, in the latter example, the two materials can be mixed as long as the upper potential is limited to 4.2V. It is an objective of the invention to use blended cathode materials in the correct voltage range and the inventor has found certain combinations that are particularly useful for high energy or high power, elaborated on later in the description.

The power and energy optimization can take place by either adjusting the formulation of the electrode, such as using higher degree of conductive additive for increased electrical conductivity, or by using different thickness electrodes. Additionally the energy cores can have one set of active materials (cathode and anode) and the power cores another type of materials. When using this method it is preferred that the materials have matched voltage range, such as 2.5-4.2V or in case of high voltage combinations 2.5V-4.5V, so as to avoid decomposition. Upper voltage is characterized as above 4.2V and is typically below 5V per isolated core member in a Li-ion multi-core battery.

The following are descriptions of anode, cathode, separator, and electrolyte which can be used in connection with this invention.

Anode

The anode of these core members are generally those commonly found in Li-ion or Li polymer batteries and described in the literature, such as graphite, doped carbon, hard carbon, amorphous carbon, Silicon (such as silicon nano particles or Si pillars or dispersed silicon with carbon), tin, tin alloys, Cu₆Sn₅, Li, deposited Li onto metal foil substrates, Si with Li, mixed in Li metal powder in graphite, lithium titanate (such as Li₂TiO₃ or Li₄Ti₅O₁₂), and any mixtures thereof. Anode suppliers include, for example, Morgan Carbon, Hitachi Chemical, Nippon Carbon, BTR Energy, JFE Chemical, Shanshan, Taiwan Steel, Osaka Gas, Conoco, FMC Lithium, Mitsubishi Chemical. The invention is not limited to any particular anode compound.

Cathode

The cathode used for the jelly rolls are generally those that are standard for the industry and also some new high voltage mixtures, which are described in more detail below. These new cathodes can be used in MC structures or in single cell batteries wherein the anode/cathode structure is contained in a sealed metal canister or a sealed polymer bag. Due to the richness of cathode materials available to the industry, the classes of materials as to each materials group herein are referred to as “Compounds”; each compound can have a range of compositions and are grouped due to similarity in crystal structure, chemical composition, voltage range suitability, or materials composition and gradient changes. Examples of suitable individual materials are LiₓCoO₂ (referred to as Compound A), LiₓM_{z}Co_{w}O₂ (Compound B, where M is selected from Mg, Ti, and Al and partly substituting Co or Li in the crystal lattice and added in the range Z=0-5%, typically W is close to 1, suitable for charge above 4.2V), LiₓNiₐMn_{b}Co_{c}O₂ (in particular the combinations of about a=l/3, b=l/3, c=l/3 (Compound C) and a=0.5, b=0.3, c=0.2 (Compound D), and Mg substituted compounds thereof (both grouped under Compound E)).

Another example is LiₓNi_{d}CoₑAl_{f}O₂ (Compound F) and its Mg substituted derivative LiₓMg_{y}Ni_{d}CoₑAl_{f}O₂ (Compound G), where in a special case d=0.8, e=0.15, f=0.05, but d, e, and f can vary with several percent, y ranges between 0 and 0.05. Yet another example of individual cathode materials are LiₓFePO₄ (Compound H), LiₓCoPO₄ (Compound I), LiMnPO₄ (Compound J), and LiₓMn₂O₄ (Compound K). In all of these compounds, an excess of lithium is typically found (x>l), but X can vary from about 0.9 to 1.1. A class of materials that is particularly suited for high voltages, possessing high capacity when charged above 4.2V, are the so-called layered-layered materials described for instance by Thackeray et al. in U.S. Pat. No. 7,358,009 and commercially available from BASF and TODA (Compound L).

The compound initially described by Thackeray can be made stable at voltages above 4.2V. Some of these cathodes are stable at high voltages, above 4.2V (the standard highest voltage using graphite as anode) and those materials can be preferably mixed. Although one of the above materials can be used in the invention, it is preferred to mix two or more of the materials compounds selected from B, C, D, E, F, G, I, J, and L. In particular, two or more component mixture of the Compounds B, D, F, G, and L is preferred. For very high energy density configurations, a mixture of (B and L) or (B and G) or (G and L) are most beneficial and when these are made as thin electrodes also high power can be achieved. The thin (power) and thick (energy) electrodes can enter into core members for tailoring of energy to power ratio, while having same suitable voltage range and chemistry.

A particular new cathode, the so-called, core shell gradient (CSG) material (referred to as Compound M), has a different composition at its core compared to its shell. For instance, Ecopro (website www.ecopro.co.kr or (http://ecopro.co.kr/xe/?mid=emenu31, as of date Oct. 1, 2010) or Patent Publn. No. PCT/KR2007/001729, which describes such a Compound M material in product literature as “CSG material” (Core Shell Gradient) as xLi [Ni_{0.8}Co_{0.1}Mn_{0.1}]O₂(1−x)Li[Ni_{0.46}Co_{0.23}Mn_{0.31}]O₂ and another M-type compound is also described by Y-K Sun in ElectrochimicaActa Vol. 55, Issue 28, p. 8621-8627, and third description of M-type compound can be found by in Nature Materials 8 (2009) p. 320-324 (article by Y K Sun et al), which describes a CSG material of similar composition but formula Bulk=Li(Ni_{0.8}Co_{0.1}Mn_{0.1}O₂, gradient concentration=Li(Ni_{0.8-x}Co_{0.1+y}Mn_{0.1+z}, where 0≤x≤0.34, 0≤y≤0.13, and 0≤z≤0.21; and surface layer=Li(Ni_{0.46}Co_{0.23}Mn_{0.31})O₂. A further description can be found in WO 2012/011785A2, describing the manufacturing of variants of Compound M described as Liₓ₁[Ni_{l-yl-zl-w}Co_{y1}Mn_{zl}M_{wl}]O₂ (where, in the above formula, 0.9≤xl≤1.3, 0.1≤yl≤0.3, 0.0≤zl≤0.3, 0≤wl≤0.1, and M is at least one metal selected from Mg, Zn, Ca, Sr, Cu, Zr, P, Fe, Al, Ga, In, Cr, Ge, and Sn); and an exterior portion including the compound of Liₓ₂[Ni_{l-y2-z2-w2}Co_{y2}Mn_{z2}M_{W2}]O₂ (where, in the exterior formula, 0.9≤x2≤l+z2, 0≤y2≤0.33, 0≤z2≤0.5, 0≤w2≤0.1 and M is at least one metal selected from Mg, Zn, Ca, Sr, Cu, Zr, P, Fe, Al, Ga, In, Cr, Ge, and Sn). All four ranges of variants of compound M are incorporated herein by reference for Compound M to be used in various aspects of the present disclosure.

It is preferred that the M compound may further have Li content that could be at about 1, but vary within a few percent and that the Li or Ni/Mn/Co compounds can be substituted with Mg, Al and first row transition metals, by optimization, and that it is preferred to blend one or more of these M compounds as described above with Compounds B, C, D, E, F, G, L for use in Li-ion batteries. It is likely that the core Compound M material can contain up to 90% nickel and as low as 5% Cobalt and up to 40% Mn, and the gradient would then go from one of these boundary compositions to as low as 10% Ni, 90% Cobalt, and 50% Mn.

In general, high power can be achieved by using thin electrodes of the compounds or blends described within this invention for anode and cathodes. A thick electrode is typically considered to be above 60 μm of thickness up to about 200 μm, when measuring the electrode coating layer thickness from the aluminum foil, while thinner electrodes (i.e. less than 60 μm) are better for high power Li-ion battery configurations. Typically for high power, more carbon black additive is used in the electrode formulations to make it more electrically conductive. Cathode compounds can be bought from several materials suppliers, such as Umicore, BASF, TODA Kogyo, Ecopro, Nichia, MGL, Shanshan, and Mitsubishi Chemical. Compound M, is available from Ecopro and described in their product literature as CSG material (such as xLi [Ni_{0.8}Co_{0.1}Mn_{0.1}]O₂(1−x)Li[Ni_{0.46}Co_{0.23}Mn_{0.31}]O₂] and another M-type compound also as described by Y-K Sun in ElectrochimicaActa, Vol. 55, Issue 28, p. 8621-8627, all of which can preferably be blended with compounds as described above.

The compounds A-M blended as two or more compounds into high voltage cathodes can preferably be coated with a surface modifier. When a surface modifier is used, it is preferred, although not necessary, that each compound is coated with the same surface modifier. The surface modifier helps increase first cycle efficiency of the cathode mixture and rate capability. Also, useful life is improved with applying the surface modifying material. Examples of surface modifiers are Al₂O₃, Nb₂O₅, ZrO₂, ZnO, MgO, TiO₂, metal fluorides such as AlF₃, metal phosphates AlPO₄ and CoPO₄. Such surface modifying compounds have been described in the literature earlier [Liu et al, J. of Materials Chemistry 20 (2010) 3961-3967; S T Myung et al, Chemistry of Materials 17 (2005) 3695-3704; S. T. Myung et al J. of Physical Chemistry C 111 (2007) 4061-4067; S T Myung et al J. of Physical Chemistry C 1154 (2010) 4710-4718; B C Park et al, J. of Power Sources 178 (2008) 826-831; J. Cho et al, J of Electrochemical Society 151 (2004) A1707-A1711], but never reported in conjunction with blended cathodes at voltages above 4.2V. In particular it is beneficial to blend surface modified compounds B, C, D, E, F, G, L, and M for operation above 4.2V.

The cathode material is mixed with a binder and carbon black, such as ketjen black, or other conductive additives. N-Methylpyrrolidone (NMP) is typically used to dissolve the binder and Polyvinylidene fluoride (PVDF) is a preferred binder for Li-ion, while Li polymer type can have other binders. The cathode slurry is mixed to stable viscosity and is well known in the art. Compounds A-M and their blends described above are herein sometimes referred collectively as “cathode active materials”. Similarly anode compounds are referred to as anode active materials.

A cathode electrode can be fabricated by mixing for instance a cathode compound, such as the blends or individual compounds of Compound A-M above, at about 94% cathode active materials and about 2% carbon black and 3% PVDF binder. Carbon black can be Ketjen black, Super P, acetylene black, and other conductive additives available from multiple suppliers including AkzoNobel, Timcal, and Cabot. A slurry is created by mixing these components with NMP solvent and the slurry is then coated onto both sides of an Aluminum foil of about 20 micrometer thickness and dried at about 100-130° C. at desired thickness and area weight. This electrode is then calendared, by rolls, to desired thickness and density.

The anode is prepared similarly, but about 94-96% anode active material, in case of graphite, is typically used, while PVDF binder is at 4%. Sometimes styrene-butadiene rubber (SBR) binder is used for cathode mixed with CMC and for that type of binder higher relative amounts of anode active materials at about 98% can typically be used. For anode, carbon black can sometimes be used to increase rate capability. Anode may be coated on copper foil of about 10 micrometer.

Those skilled in the art would easily be able to mix compositions as described above for functional electrodes.

To limit electrode expansion during charge and discharge fiber materials of polyethylene (PE), polypropylene (PP), and carbon can optionally be added to the electrode formulation. Other expansion techniques use inert ceramic particulates such as SiO₂, TiO₂, ZrO₂ or Al₂O₃ in the electrode formulation. Generally the density of cathodes is between 3 and 4 g/cm³, preferably between 3.6 and 3.8 g/cm³ and graphite anodes between 1.4 and 1.9 g/cm³, preferably 1.6-1.8 g/cm³, which is achieved by the pressing.

Separator

The separator generally takes the form of an electrically insulating film that is inserted between anode and cathode electrodes and should have high permeability for Li ions as well as high strength in tensile and transverse direction and high penetration strength. The pore size is typically between 0.01 and 1 micrometer and thickness is between 5 micrometer and 50 micrometer. Sheets of non-woven polyolefins, such as polyethylene (PE), polypropylene (PP) or PP/PE/PP structures are typically used. A ceramic, typically consisting of Al₂O₃, may be applied onto the film to improve shrinking upon heating and improve protection against internal shorts. Also the cathode or the anode can be coated similarly with a ceramic. Separators can be procured from multiple suppliers in the industry including Celgard, SK, Ube, Asahi Kasei, Tonen/Exxon, and WScope.

Electrolyte

The electrolyte is typically found in the industry containing solvents and salts. Solvents are typically selected between DEC (diethyl carbonate), EC (ethylene carbonate), EMC (ethyl methyl carbonate), PC (propylene carbonate), DMC (dimethyl carbonate), 1,3dioxolane, EA (ethyl acetate), tetrahydrofuran (THF). Salts are selected between LiPF₆, LiClO₄, LiAsF₆, LiBF₄, sulfur or imide containing compounds used in electrolyte includes LiCFSO₃, LiN(CF₃SO₂)₂, LiN(CF₃CF₂SO₂)₂, or a plain sulfonation by bubbling SO₂ through a premixed electrolyte such as EC/EMC/DMC (1:1:1 ratio) and 1M LiPF₆. Other salts are LiBOB (Lithium Bis-oxalateborate), TEATFB (tetraethylammoniumtetrafluoroborate), TEMABF4 (triethylmethylammoniumtetrafluoroborate). Additive for effective SEI formation, gas generation, flame retardant properties, or redox shuttling capability can also be used, including BP (biphenyl), FEC, pyridine, triethylphosphite, triethanolamine, ethylenediamine, hexaphosphorictriamide, sulfur, PS (propylenesulfite), ES (ethylenesulfite), TPP (triphenylphosphate), ammonium salts, halogen containing solvents, such as carbon tetrachloride or ethylene trifluoride and additionally CO₂ gas to improve high temperature storage characteristics. For solid/gel or polymer electrolytes PVDF, PVDF-HFP, EMITFSI, LiTFSI, PEO, PAN, PMMA, PVC, any blends of these polymers, can be used along with other electrolyte components to provide a gel electrolyte. Electrolyte suppliers include Cheil, Ube, Mitsubishi Chemical, BASF, Tomiyama, Guotsa-Huasong, and Novolyte.

There are electrolytes that work for both supercapacitors (those having electrochemical double layers) and standard Li-ion batteries. For those electrolytes one or more super capacitor cores can be mixed with one or more regular Li-ion core member in an enclosure, so that the supercapacitor component works as a power agent and the Li-ion core member as an energy harvesting agent.

The opacifier is a component that may augment the performance of the insulating material during thermal upset conditions where the temperatures rise into the levels of radiant heat. The need for opacifiers is generally dependent upon the heat release characteristics of the energy storage device/battery analogous to the description above for the microporous component. If the temperatures during a thermal event are sufficiently high to reach radiant heat temperatures, then an opacifier will help to slow transmission of any radiant heat generated. In this application, neither the microporous material, the fiber matrix nor a combination thereof is effective against radiant heat transfers by themselves. Common opacifier materials include TiO₂, silicon, alumina, clay (which may function both as opacifier and binder), SiC and heavy metal oxides. These opacifiers do not provide any function according to the present disclosure at normal operating temperatures or even at lower temperatures during a thermal event. The opacifiers tend to be high in cost and very dense and, therefore, add weight to the storage device/battery. Depending upon the design of the energy storage unit/battery and the nature of the heat release during a thermal event, the range for opacifier additions generally ranges from 0 to 30 percent.

The endothermic material constituent offers significant benefits according to exemplary embodiment of the present disclosure. It is known that most energy storage devices/lithium ion batteries function well at 60° C. or below. The disclosed endothermic materials/systems of the present disclosure are generally designed and/or selected to begin their respective endothermic reaction(s) above this temperature, but preferably low enough that the endothermic materials/systems can begin absorbing heat energy generated during a thermal event at the initial moments of such an event to minimize temperature rise in the affected cells and adjacent cells. Upon exceeding a set level above the normal operating temperature, the endothermic material absorbs heat and evolves gas. The evolving gas serves to dilute, neutralize and carry away heat. Also, the sudden generation of heat can be used to signal or cause the vents in energy storage devices to begin venting. The amount of endothermic material needed or desired generally depends upon device configuration, energy density and thermal conductivity of the remainder of the insulating material components. Endothermic materials/systems with 76% or more by weight endothermic gas-generating material are contemplated, although differing ratios and/or ranges may be employed without departing from the spirit or scope of the present disclosure.

The amount of endothermic gas-generating material may also be regulated to achieve a desired volume of gas generation and the selection of type can be used to set the temperature at which the endothermic gas generation should occur. In highly insulating systems, a higher temperature may be desired whereas, in less insulating systems, a lower temperature may be needed to prevent temperatures in neighboring cells reaching critical ignition temperature. Typical inorganic endothermic materials that would meet these requirements include, but are not limited to, the following endothermic materials:

TABLE

| | | Approximate onset of |
|---|---|---|
| Mineral | Chemical Formula | Decomposition (° C.) |
| Nesquehonite | MgCO₃•3H₂O | 70-100 |
| Gypsum | CaSO₄•2H₂O | 60-130 |
| Magnesium phosphate octahydrate | Mg₃(PO₄)₂•8H₂O | 140-150 |
| Aluminium hydroxide | Al(OH)₃ | 180-200 |
| Hydromagnesite | Mg₅(CO₃)₄(OH)₂•4H₂O | 220-240 |
| Dawsonite | NaAl(OH)₂CO₃ | 240-260 |
| Magnesium hydroxide | Mg(OH)₂ | 300-320 |
| Magnesium carbonate subhydrate | MgO•CO_{2(0.95)}H₂O_{(0.3)} | 340-350 |
| Boehmite | AlO(OH) | 340-350 |
| Calcium hydroxide | Ca(OH)₂ | 430-450 |

As noted above, these endothermic materials typically contain hydroxyl or hydrous components, possibly in combination with other carbonates or sulphates. Alternative materials include non-hydrous carbonates, sulphates and phosphates. A common example would be sodium bicarbonate which decomposes above 50° C. to give sodium carbonate, carbon dioxide and water.

In an exemplary embodiments of the present disclosure, a plurality of endothermic materials are incorporated into the same energy storage device/lithium ion battery, wherein the constituent endothermic materials initiate their respective endothermic reactions at different temperatures. For example, sodium bicarbonate may be combined with Al(OH)₃ [also known as ATH (aluminum trihydrate)] to provide a dual response endothermic material/system according to the present disclosure. In such exemplary implementation, the sodium bicarbonate can be expected to begin absorbing energy and evolving gas slightly above 50° C., whereas ATH would not begin absorbing energy and evolving gas until the system temperature reached approximately 180-200° C. Thus, it is specifically contemplated according to the present disclosure that the endothermic material may be a single material or mixture of endothermic materials.

It should be noted that some materials have more than one decomposition temperature. For example, hydromagnesite referred to above as having a decomposition temperature starting in the range 220-240° C. decomposes in steps: first by release of water of crystallization at about 220° C.; then at about 330° C. by breakdown of hydroxide ions to release more water; then at about 350° C. to release carbon dioxide. However, these steps in decomposition are fixed and do not permit control of at what temperatures heat is absorbed and at what temperatures gas is generated.

By use of a mixture of two or more endothermic materials having different decomposition temperatures, the cooling effect can be controlled over a wider temperature range than with one material alone. The two or more endothermic materials may comprise one or more non-gas generating endothermic materials in combination with one or more gas-generating materials.

By use of a mixture of two or more endothermic materials evolving gas at different decomposition temperatures, the production of gas can be controlled over a wider temperature range than with one material alone. The number and nature of endothermic materials used can hence be tailored to give tailored heat absorption and gas evolution profiles. Such tailoring of heat absorption and gas evolution profiles by mixing different endothermic materials allows the control of the evolution of temperature and pressure to meet design requirements of the apparatus in which the material is used.

It is noted that the venting functionalities associated with the disclosed energy storage devices/lithium ion batteries may take the form of a single vent element that is pressure and/or temperature sensitive, or multiple vent elements that are pressure and/or temperature sensitive. Vent elements may operate to initiate venting at pressures above 3 bars and, in exemplary implementations, at pressures in the range of 5-15 bars, although the selection of operative pressure-release parameters may be influenced by the design and operation of the specific energy storage device/lithium battery. More particularly, the disclosed vent may operate to initiate venting at a predetermined threshold pressure level that falls between about 15 psi and 200 psi, preferably between about 30 psi and 170 psi, and more preferably between about 60 psi and 140 psi.

In further exemplary embodiments of the present disclosure, the venting element(s) may include a flame arrestor that is designed, in whole or in part, to prevent flash back into the cell. For example, a flame arrestor in the shape of a wire mesh may be employed, although alternative designs and/or geometries may be employed, as will be readily apparent to persons skilled in the art.

It is further contemplated that in the case of implementations that include multiple vent elements, the operations of the vent elements may be triggered, in whole or in part, by responsive actions of other vent elements within the overall device/battery. For example, actuation of venting functionality of a first vent element may automatically trigger venting functionality of one or more of the other vent elements associated with the device/battery. Still further, multiple vent elements may be provided that are characterized by different venting thresholds, such that a first vent element may be actuated at a first temperature and/or pressure, whereas a second vent element may be actuated at a second temperature and/or pressure that is higher than the first temperature/pressure.

It is further noted that the vent gases associated with the endothermic reaction(s) dilute the electrolyte gases to provide an opportunity to postpone or eliminate the ignition point and/or flammability associated with the electrolyte gases. Dilution of the electrolyte gases is highly advantageous and represents a further advantage associated with the systems and methods of the present disclosure. [Cf. E. P. Roth and C. J. Orendorff, “How Electrolytes Influence Battery Safety,” The Electrochemical Society Interface, Summer 2012, pgs. 45-49.]

In implementing the disclosed endothermic materials/systems, it is contemplated that different formulations and/or quantities may be associated with different cells in a multi-core cell structure. For example, centrally located cells may be clustered and provided with endothermic materials/systems that initiate endothermic reaction(s) at lower temperatures as compared to outer cells based on the likelihood that inner cells may experience earlier abuse temperatures compared to outer cells.

It is noted that when the disclosed endothermic materials/systems are included inside a cell with exposure to electrolyte, e.g., through partial vapor pressure, the transfer of water to the jelly rolls from the endothermic materials/systems is limited and/or non-existent because the water associated with the endothermic material/system is chemically bound. In implementations where the endothermic material/system is positioned/located, in whole or in part, inside these cells, it is important to limit the exposure of water to electrolyte. If the endothermic material/system contains water, the vapor pressure of water associated with the endothermic material/system should be low to limit the potential interference with electrolyte functionality Indeed, the non-transfer of water to the electrolyte is important in ensuring that the functionality of the underlying cell is not compromised by the presence of the disclosed endothermic materials/systems. This feature is especially important for those configurations where the core is open to the general atmosphere inside an otherwise hermetically sealed cell.

Of note, even after the endothermic material associated with the disclosed endothermic materials/systems has been consumed, i.e., the endothermic reaction(s) associated with such endothermic material have consumed all available endothermic material, the disclosed endothermic materials/systems continue to provide advantageous insulating functionality to the energy storage device/lithium ion battery by reason of the other insulative constituents associated with the endothermic materials/systems.

As will be readily apparent to persons skilled in the art, the present disclosure may be embodied in other specific forms without departing from the spirit or essential characteristics thereof. The present embodiments are therefore to be considered in all respects as illustrative and not restrictive.

1. A multi-core lithium ion battery, comprising:
a housing including a base and a plurality of sidewalls that define one or more hollow spaces and an internal volume, wherein a plurality of cavities are formed within the internal volume of the housing,
a first covering plate mounted with respect to the housing in substantial alignment with the base so as to enclose the internal volume of the housing,
a plurality of lithium ion core members positioned within the housing, wherein one of the plurality of the lithium ion core members is disposed in one of the plurality of cavities; and
one or more filler materials disposed in the one or more hollow spaces so as to be in proximity to one or more of the lithium ion core members.

2. The lithium ion battery of claim 1, wherein a region is defined between the housing and the first covering plate that constitutes a shared atmosphere region in communication with each of the plurality of lithium ion core members.

3. The lithium ion battery of claim 1, wherein the plurality of cavities are substantially U-shaped such that the one or more hollow spaces is defined by the plurality of U-shaped cavities and the base of the housing, and wherein at least a portion of the one or more hollow spaces is filled with the one or more filler materials.

4. The lithium ion battery of claim 1, wherein the filler material includes one or more constituents that exhibit endothermic properties.

5. The lithium ion battery of claim 1, wherein the filler material exhibits energy absorbing properties.

6. The lithium ion battery of claim 1, wherein the filler material includes one or more constituents that exhibit fire retardant properties.

7. The lithium ion battery of claim 1, wherein the filler material is selected from a group consisting of liquids, foams, hollow media, dense media, regularly shaped media, irregularly shaped media, and a combination thereof.

8. The lithium ion battery of claim 1, further comprising an electrical connector mounted with respect to the housing, therein electrically connecting the lithium ion core members to an electrical terminal external to the sealed enclosure.

9. The lithium ion battery of claim 8, wherein said electrical connector comprises two bus bars, the first bus bar interconnecting the anodes of said core members to a negative terminal member of the terminal external to the enclosure, the second bus bar interconnecting the cathodes of said lithium ion core members to a positive terminal member of the terminal external to the enclosure.

10. The lithium ion battery of claim 9, wherein the lithium ion core members are connected in parallel.

11. The lithium ion battery of claim 9, wherein the lithium ion core members are connected in series.

12. The lithium ion battery of claim 9, wherein a first set of lithium ion core members are connected in parallel and a second set of lithium ion core members are connected in parallel, and the first set of lithium ion core members is connected in series with the second set of lithium ion core members.

13. The lithium ion battery of claim 1, further comprising an enclosure in which the housing is positioned, and wherein the enclosure is hermetically sealed.

14. The lithium ion battery of claim 1, wherein each of the plurality of cavities includes a surface plating on an inside surface thereof.

15. The lithium ion battery of claim 1, further comprising a port for injecting the filler material into the one or more hollow spaces.

16. (canceled)

17. The lithium ion battery of claim 1, further comprising pressure vents for relieving pressure build up within the enclosure above a predetermined threshold.

18. The lithium ion battery of claim 14, wherein the plating material is selected from a group consisting of nickel, zinc, and a combination thereof.

19. The lithium ion battery of claim 1, wherein at least one of the housing, the first covering plate, and the filler are at least partially fabricated from a thermal insulating mineral material.

20. The lithium ion battery of claim 19, wherein the thermal insulating mineral material is selected from a group consisting of alkaline earth silicate wool, basalt fiber, asbestos, volcanic glass fiber, fiberglass, cellular glass, and any combination thereof.

21. The lithium ion battery of claim 19, wherein the thermal insulating mineral material further comprises a binding material, which is selected from a group consisting of nylon, PVC, PVA, acrylic polymers, and any combination thereof.

22. (canceled)

23. A multi-core lithium ion battery, comprising:
a housing including a base and a plurality of sidewalls that define one or more hollow spaces and an internal volume;
a support member positioned within the housing, wherein the support member defines a plurality of cavities;
a first covering plate mounted with respect to the housing in substantial alignment with the base so as to enclose the internal volume of the housing;
a plurality of lithium ion core members, disposed within a corresponding one of the plurality of cavities; and
one or more filler materials in the one or more hollow spaces so as to be in proximity to one or more of the lithium ion core members.

24. The lithium ion battery of claim 23, wherein the support member is at least partially hollow.

25. The lithium ion battery of claim 24, wherein at least a portion of the hollow support member is filled with the one or more filler materials.

26. The lithium ion battery of claim 23, wherein the filler material includes one or more constituents that exhibit endothermic properties.

27. (canceled)

28. (canceled)

29. The lithium ion battery of claim 23, wherein the filler material is selected from a group consisting of liquids, foams, hollow media, dense media, regularly shaped media, irregularly shaped media, and a combination thereof.

30. (canceled)

31. (canceled)

32. (canceled)

33. The lithium ion battery of claim 23, wherein at least one of the housing, the first covering plate, the filler, and the support member are at least partially fabricated from a thermal insulating mineral material.

34. The lithium ion battery of claim 33, wherein the thermal insulating mineral material is selected from a group consisting of alkaline earth silicate wool, basalt fiber, asbestos, volcanic glass fiber, fiberglass, cellular glass, and any combination thereof.

35. The lithium ion battery of claim 33, wherein the thermal insulating mineral material further comprises a binding material, which is selected from a group consisting of nylon, PVC, PVA, acrylic polymers, and any combination thereof.

36. (canceled)
